(19) United States
(12) Patent Application Publication
(10) Pub. No.: US 2026/0230223 A1
(43) Pub. Date: Aug. 6, 2026

(54) BIT MAPPING METHOD AND APPARATUS

(71) Applicant: Huawei Technologies Co., Ltd., Shenzhen (CN)

(72) Inventors: Jiajie Tong, Hangzhou (CN); Xianbin Wang, Hangzhou (CN); Huazi Zhang, Hangzhou (CN); Kangjian Qin, Hangzhou (CN); Ke Liu, Hangzhou (CN); Jun Wang, Hangzhou (CN)

(21) Appl. No.: 19/577,958

(22) Filed: Mar. 25, 2026

Related U.S. Application Data
(63) Continuation of application No. PCT/CN2023/121811, filed on Sep. 26, 2023.

(51) Int. Cl. H04L 1/00

(52) U.S. Cl. CPC H04L 1/0067; H04L 1/0057

(57) ABSTRACT

This application provides a bit mapping method and an apparatus. In the method, a first bit sequence is divided into Y sub-blocks, and each sub-block is punctured and/or shortened, so that at least some bits (for example, Ai bits) of each sub-block can be discarded, and the discarded bits are relatively even.

### CROSS-REFERENCE TO RELATED APPLICATIONS

This application is a continuation of International Application No. PCT/CN2023/121811, filed on Sep. 26, 2023, the disclosure of which is hereby incorporated by reference in its entirety.

### TECHNICAL FIELD

This application relates to the field of communication technologies, and in particular, to a bit mapping method and an apparatus.

### BACKGROUND

In a new radio (NR) system, rate matching of an NR polar code is to divide a mother code of the polar code into 32 sub-blocks and perform interleaving in an order defined in a protocol, for example, a sub-block 0, a sub-block 1, a sub-block 2, a sub-block 4, a sub-block 3, a sub-block 5, a sub-block 6, a sub-block 7, a sub-block 8, a sub-block 16, a sub-block 9, a sub-block 17, . . . , a sub-block 27, a sub-block 29, a sub-block 30, and a sub-block 31. However, this interleaving manner still has a pit. For example, if a code length M of a to-be-sent sequence is 641, K information bits include 250 data bits and 24 CRC bits, and a code rate is 0.446, puncturing positions are 0 to 319 and 512 to 574. In this case, a bit position 575 is selected as an information bit position, but it is actually found that a capacity of the bit position 575 is almost equal to 0, resulting in a performance pit. Consequently, an SNR required for normal communication is very high, and communication efficiency is reduced.

Therefore, how to avoid occurrence of a performance pit caused by rate matching as much as possible is a hot topic in current research.

### SUMMARY

Embodiments of this application provide a bit mapping method and an apparatus, to avoid a performance pit caused by rate matching as much as possible.

To achieve the foregoing objective, this application uses the following technical solutions.

According to a first aspect, a bit mapping method is provided. The method includes: obtaining a to-be-sent bit sequence; obtaining a first bit sequence, where a length of the to-be-sent bit sequence is M, M is a positive integer, a length of the first bit sequence is N, N is a positive integer, and M is less than N; dividing the first bit sequence into Y sub-blocks; determining Ai bits of an i^{th} sub-block as to-be-discarded bits, to obtain a second bit sequence, where i traverses 1 to Y, and Ai is greater than or equal to 1; and mapping the to-be-sent bit sequence to the second bit sequence, where there are N−M to-be-discarded bits in the Y sub-blocks, each of the Y sub-blocks includes X bits, and X and Y are integers greater than 1.

It can be learned from the method according to the first aspect that the first bit sequence is divided into the Y sub-blocks, and each sub-block is punctured and/or shortened, so that at least some bits (for example, Ai bits) of each sub-block can be discarded, and the discarded bits are relatively even. This reduces impact on a communication capacity, and reduces a possibility of occurrence of a performance pit, thereby ensuring communication efficiency.

It may be understood that the method according to the first aspect may be performed by a first communication apparatus. The first communication apparatus may be a terminal, includes the terminal itself, or may be a chip in the terminal. Alternatively, the first communication apparatus may be a network device, includes the network device itself, or may be a chip in the network device. For ease of description, the following uses an example in which the method according to the first aspect is performed by the first communication apparatus for description.

In a possible design solution, the Ai bits of the i^{th} sub-block are Ai bits with largest indexes in the X bits of the i^{th} sub-block, or the Ai bits of the i^{th} sub-block are Ai bits with largest index reversal values in the X bits of the i^{th} sub-block, or the Ai bits of the i^{th} sub-block are Ai bits with highest reliability in the X bits of the i^{th} sub-block.

It may be understood that, in comparison with an ascending order of the indexes or the index reversal values, this manner can allow the to-be-discarded bits to have small impact or almost no impact on the communication capacity, to avoid a decrease in communication efficiency due to occurrence of a pit region.

In a possible design solution, a minimum value of Ai is Amin, and Amin is a value obtained by rounding down (N−M)/Y. In other words, at least one bit with a same index or a same index reversal value in each sub-block is determined as a to-be-discarded bit or a to-be-shortened bit. If the Y sub-blocks are considered as Y columns, and the X bits included in each sub-block are considered as X rows, the Y sub-blocks are interleaved, for example, in an interleaving order that is an order of the Y sub-blocks in the first bit sequence, to obtain a matrix with X rows and Y columns. Bits with a same index in each sub-block may be understood as one row of the matrix. Correspondingly, Amin rows of bits in the matrix are determined as to-be-discarded bits, to implement relatively even shortening and avoid impact on the communication capacity.

In another possible design solution, a minimum value of Ai is Amin, and Amin is determined based on a value obtained by rounding down (N−M)/Y. For example, the value obtained by rounding down (N−M)/Y is A. If A is greater than or equal to a preset value, Amin is the preset value; or if A is less than the preset value, Amin is A. The preset value may indicate that at most a preset quantity of rows of bits in the matrix can be all discarded, to avoid a decrease in the communication capacity due to discarding too many rows as a whole.

Optionally, if B=(N−M)−Amin*Y and B is a positive integer, in Z sub-blocks of the Y sub-blocks, a j^{th} sub-block has Amin+Dj to-be-discarded bits, where Z is a positive integer less than Y in most cases, but imposes no limitation, Z may alternatively be equal to Y, j traverses 1 to Z, and a sum of D1 to Dz is B. In other words, the first communication apparatus may continue to select B bits from the Z sub-blocks of the Y sub-blocks as to-be-discarded bits, to ensure that all redundant bits can be finally discarded.

Optionally, when Z is greater than 1, X bits of each Z−1 sub-blocks in the Z sub-blocks are all to-be-discarded bits.

For example, when the Z sub-blocks are Z sub-blocks with smallest indexes in the Y sub-blocks, the Z−1 sub-blocks are Z−1 sub-blocks with smallest indexes in the Z sub-blocks; or when the Z sub-blocks are Z sub-blocks with smallest index reversal values in the Y sub-blocks, the Z−1 sub-blocks are Z−1 sub-blocks with smallest index reversal values in the Z sub-blocks. For another example, when the Z sub-blocks are Z sub-blocks with largest indexes in the Y sub-blocks, the Z−1 sub-blocks are Z−1 sub-blocks with largest indexes in the Z sub-blocks; or when the Z sub-blocks are Z sub-blocks with largest index reversal values in the Y sub-blocks, the Z−1 sub-blocks are Z−1 sub-blocks with largest index reversal values in the Z sub-blocks.

If a coding rate is less than or equal to a code rate threshold, the Z sub-blocks are Z sub-blocks with smallest indexes in the Y sub-blocks, or the Z sub-blocks are Z sub-blocks with smallest index reversal values in the Y sub-blocks; or if a coding rate is greater than the code rate threshold, the Z sub-blocks are Z sub-blocks with largest indexes in the Y sub-blocks, or the Z sub-blocks are Z sub-blocks with largest index reversal values in the Y sub-blocks.

It may be understood that the Z sub-blocks are selected in ascending order when the coding rate is low, or the Z sub-blocks are selected in descending order when the coding rate is high. In this way, impact of the selected to-be-discarded bits on the communication capacity can be avoided, thereby avoiding a decrease in communication efficiency and ensuring communication stability.

Optionally, alternatively, the Z sub-blocks may be Z sub-blocks with lowest reliability in the Y sub-blocks, and the Z−1 sub-blocks are Z−1 sub-blocks with lowest reliability in the Z sub-blocks. Alternatively, the Z sub-blocks may be Z sub-blocks with highest reliability in the Y sub-blocks, and the Z−1 sub-blocks are Z−1 sub-blocks with highest reliability in the Z sub-blocks. It may be understood that reliability of a sub-block may be represented by reliability of any bit (for example, a 1st bit) of the sub-block, or may be an average reliability value of at least some bits in the sub-block.

Optionally, Z is a value obtained by rounding up B/(X−A), or may be determined in any other possible manner. This is not limited herein.

According to a second aspect, a rate matching method is provided. The method includes: obtaining to-be-decoded information; obtaining a first bit sequence, where a length of the first bit sequence is N, and N is a positive integer; dividing the first bit sequence into Y sub-blocks, where each of the Y sub-blocks includes X bits, and X and Y are integers greater than 1; determining Ai bits of an i^{th} sub-block as to-be-discarded bits, to obtain a second bit sequence, where i traverses 1 to Y, Ai is greater than or equal to 1, and there are N−M to-be-discarded bits in the Y sub-blocks; and decoding, based on the second bit sequence, the to-be-decoded information, to obtain M information bits, where M is a positive integer less than N.

It may be understood that the method according to the second aspect may be performed by a second communication apparatus. The second communication apparatus may be a terminal, includes the terminal itself, or may be a chip in the terminal. Alternatively, the second communication apparatus may be a network device, includes the network device itself, or may be a chip in the network device. For ease of description, the following uses an example in which the method according to the second aspect is performed by the second communication apparatus for description.

In a possible design solution, the Ai bits of the i^{th} sub-block are Ai bits with largest indexes in the X bits of the i^{th} sub-block, or the Ai bits of the i^{th} sub-block are Ai bits with largest index reversal values in the X bits of the i^{th} sub-block, or the Ai bits of the i^{th} sub-block are Ai bits with highest reliability in the X bits of the i^{th} sub-block.

In a possible design solution, a minimum value of Ai is Amin, and Amin is a value obtained by rounding down (N−M)/Y.

In another possible design solution, Amin is determined based on a value obtained by rounding down (N−M)/Y. For example, the value obtained by rounding down (N−M)/Y is A. If A is greater than or equal to a preset value, Amin is the preset value; or if A is less than the preset value, A is Amin. The preset value may indicate that at most a preset quantity of rows of bits in a matrix can be all discarded, to avoid a decrease in the communication capacity due to discarding too many rows as a whole.

Optionally, if B=(N−M)−Amin*Y and B is a positive integer, in Z sub-blocks of the Y sub-blocks, a j^{th} sub-block has Amin+Dj to-be-discarded bits, where Z is a positive integer less than or equal to Y, j traverses 1 to Z, and a sum of D1 to Dz is B.

Optionally, when Z is greater than 1, X bits of each Z−1 sub-blocks in the Z sub-blocks are all to-be-discarded bits.

For example, when the Z sub-blocks are Z sub-blocks with smallest indexes in the Y sub-blocks, the Z−1 sub-blocks are Z−1 sub-blocks with smallest indexes in the Z sub-blocks; or when the Z sub-blocks are Z sub-blocks with smallest index reversal values in the Y sub-blocks, the Z−1 sub-blocks are Z−1 sub-blocks with smallest index reversal values in the Z sub-blocks. For another example, when the Z sub-blocks are Z sub-blocks with largest indexes in the Y sub-blocks, the Z−1 sub-blocks are Z−1 sub-blocks with largest indexes in the Z sub-blocks; or when the Z sub-blocks are Z sub-blocks with largest index reversal values in the Y sub-blocks, the Z−1 sub-blocks are Z−1 sub-blocks with largest index reversal values in the Z sub-blocks.

If a coding rate is less than or equal to a code rate threshold, the Z sub-blocks are Z sub-blocks with smallest indexes in the Y sub-blocks, or the Z sub-blocks are Z sub-blocks with smallest index reversal values in the Y sub-blocks; or if a coding rate is greater than the code rate threshold, the Z sub-blocks are Z sub-blocks with largest indexes in the Y sub-blocks, or the Z sub-blocks are Z sub-blocks with largest index reversal values in the Y sub-blocks.

Optionally, Z is a value obtained by rounding up B/(X−A).

It may be understood that, for related technical effects of the method in the second aspect, refer to the related descriptions of the first aspect. Details are not described herein again.

According to a third aspect, a communication apparatus is provided. The communication apparatus includes a module configured to perform the method according to any one of the first aspect and the second aspect, for example, a transceiver module and a processing module. For example, the transceiver module is configured to indicate receiving and sending functions of the communication apparatus, and the processing module is configured to perform a function of the communication apparatus other than the receiving and sending functions.

Optionally, the transceiver module may include a sending module and a receiving module. The sending module is configured to implement the sending function of the communication apparatus according to the third aspect, and the receiving module is configured to implement the receiving function of the communication apparatus according to the third aspect.

Optionally, the communication apparatus according to the third aspect may further include a storage module. The storage module stores a program or instructions. When the processing module executes the program or the instructions, the communication apparatus is caused to perform the method according to any one of the first aspect and the second aspect.

It may be understood that the communication apparatus according to the third aspect may be a terminal or a network device, may be a chip (system) or another part or component that may be disposed in a terminal or a network device, or may be an apparatus that includes a terminal or a network device. This is not limited in this application.

In addition, for technical effects of the communication apparatus according to the third aspect, refer to the technical effects of the foregoing other aspects. Details are not described herein again.

According to a fourth aspect, a communication apparatus is provided. The communication apparatus includes a processor, and the processor is configured to perform the method according to any one of the first aspect and the second aspect.

In a possible design solution, the communication apparatus according to the fourth aspect may further include a transceiver. The transceiver may be a transceiver circuit or an interface circuit. The transceiver may be used by the communication apparatus according to the fourth aspect to communicate with another communication apparatus.

In a possible design solution, the communication apparatus according to the fourth aspect may further include a memory. The memory and the processor may be integrated together, or may be disposed separately. The memory may be configured to store a computer program and/or data related to the method according to any one of the first aspect and the second aspect.

In embodiments of this application, the communication apparatus according to the fourth aspect may be the terminal or the network device according to any one of the first aspect and the second aspect, a chip (system) or another part or component that may be disposed in the terminal or the network device, or an apparatus that includes the terminal or the network device.

In addition, for technical effects of the communication apparatus according to the fourth aspect, refer to the technical effects of the method according to any one of the first aspect and the second aspect. Details are not described herein again.

According to a fifth aspect, a communication apparatus is provided. The communication apparatus includes a processor. The processor is coupled to a memory. The processor is configured to execute a computer program stored in the memory, to enable the communication apparatus to perform the method according to any one of the first aspect and the second aspect.

In a possible design solution, the communication apparatus according to the fifth aspect may further include a transceiver. The transceiver may be a transceiver circuit or an interface circuit. The transceiver may be used by the communication apparatus according to the fifth aspect to communicate with another communication apparatus.

In embodiments of this application, the communication apparatus according to the fifth aspect may be the terminal or the network device according to any one of the first aspect and the second aspect, a chip (system) or another part or component that may be disposed in the terminal or the network device, or an apparatus that includes the terminal or the network device.

In addition, for technical effects of the communication apparatus according to the fifth aspect, refer to the technical effects of the method according to any one of the first aspect and the second aspect. Details are not described herein again.

According to a sixth aspect, a communication apparatus is provided, including a processor and a memory. The memory is configured to store a computer program. When the processor executes the computer program, the communication apparatus is caused to perform the method according to any one of the first aspect and the second aspect.

In a possible design solution, the communication apparatus according to the sixth aspect may further include a transceiver. The transceiver may be a transceiver circuit or an interface circuit. The transceiver may be used by the communication apparatus according to the sixth aspect to communicate with another communication apparatus.

In embodiments of this application, the communication apparatus according to the sixth aspect may be the terminal or the network device according to any one of the first aspect and the second aspect, a chip (system) or another part or component that may be disposed in the terminal or the network device, or an apparatus that includes the terminal or the network device.

In addition, for technical effects of the communication apparatus according to the sixth aspect, refer to the technical effects of the method according to any one of the first aspect and the second aspect. Details are not described herein again.

According to a seventh aspect, a communication system is provided. The communication system includes a first communication apparatus configured to perform the method according to the first aspect, and a second communication apparatus configured to perform the method according to the second aspect.

According to an eighth aspect, a computer-readable storage medium is provided, including a computer program or instructions. When the computer program or the instructions are run on a computer, the computer is caused to perform the method according to any one of the first aspect and the second aspect.

According to a ninth aspect, a computer program product is provided, including a computer program or instructions. When the computer program or the instructions are run on a computer, the computer is caused to perform the method according to any one of the first aspect and the second aspect.

### BRIEF DESCRIPTION OF THE DRAWINGS

FIG. 1 is a diagram of 8*8 polar code coding;

FIG. 2 is a diagram of NAT rate matching;

FIG. 3 is a diagram of NR rate matching;

FIG. 4 is a diagram 1 of an architecture of a communication system according to an embodiment of this application;

FIG. 5 is a diagram 2 of an architecture of a communication system according to an embodiment of this application;

FIG. 6 is a schematic flowchart of a rate matching method according to an embodiment of this application;

FIG. 7 is a diagram 1 of an application scenario of a rate matching method according to an embodiment of this application;

FIG. 8 is a diagram 2 of an application scenario of a rate matching method according to an embodiment of this application;

FIG. 9 is a diagram 3 of an application scenario of a rate matching method according to an embodiment of this application;

FIG. 10 is a diagram 1 of a structure of a communication apparatus according to an embodiment of this application; and

FIG. 11 is a diagram 2 of a structure of a communication apparatus according to an embodiment of this application.

### DETAILED DESCRIPTION OF ILLUSTRATIVE EMBODIMENTS

For ease of understanding, the following first describes technical terms in embodiments of this application.

### 1. Polar Code:

The polar code is a channel coding scheme that can reach a Shannon channel capacity, and features good performance, low complexity, and the like. Currently, the polar code has been determined by a 3rd generation partnership project (3GPP) as an uplink/downlink control channel coding scheme in a 5th generation (5G) enhanced mobile broadband (eMBB) scenario.

FIG. 1 is a diagram of 8*8 polar code coding. As shown in FIG. 1, “+” represents an exclusive OR operation, and to-be-encoded bits are sorted based on reliability of the to-be-encoded bits. Generally, a bitwith high reliability is set as an information bit. For example, U⁷, U⁶, U⁵, and U³ are 4 bits with highest reliability, and are set as information bits. A bit with low reliability is set as a frozen bit. For example, U⁴, U², U¹, and U⁰ are 4 bits with lowest reliability, and are set as frozen bits. A value of the frozen bit is usually set to 0, and is known to both a transmit end and a receive end during actual transmission.

It can be learned that a length of a mother code of the polar code is an integer power of 2. When a code length required for actual communication is not the length of the mother code, a code length matching process needs to be further implemented in a manner such as puncturing or retransmission. In other words, puncturing or retransmission is to remove or retransmit several bit positions from a sequence obtained through encoding, to meet a code length requirement of an encoded sequence. This process is also referred to as rate matching.

Currently, there are mainly two rate matching manners. One is natural order (Nature, NAT) puncturing, and the other is new radio (NR) sub-block interleaving, which are separately described below.

### 2. Nat Puncturing:

NAT puncturing is performed in a natural order from front to back.

For example, a to-be-sent sequence is a polar code whose code length is M, the to-be-sent sequence includes K information bits, M and K are positive integers, and M is greater than K. A transmitter determines that a code length of a mother code corresponding to the to-be-sent sequence is N. In most cases, N is an integer greater than M. In a few cases, for example, a code rate of the to-be-sent sequence is less than ⅛, or the to-be-sent sequence is slightly longer than a half of the mother code and a code rate is not high, or the to-be-sent sequence exceeds a specified maximum length of the mother code, where N is less than M. When N is greater than M, the transmitter selects first N−M bit positions of the mother code as puncturing positions, and freezes the N−M bit positions, that is, sets a value of a bit to 0, without placing any information. In this case, some frozen bits are additionally added based on a quantity of punctured bits, to avoid performance collapse.

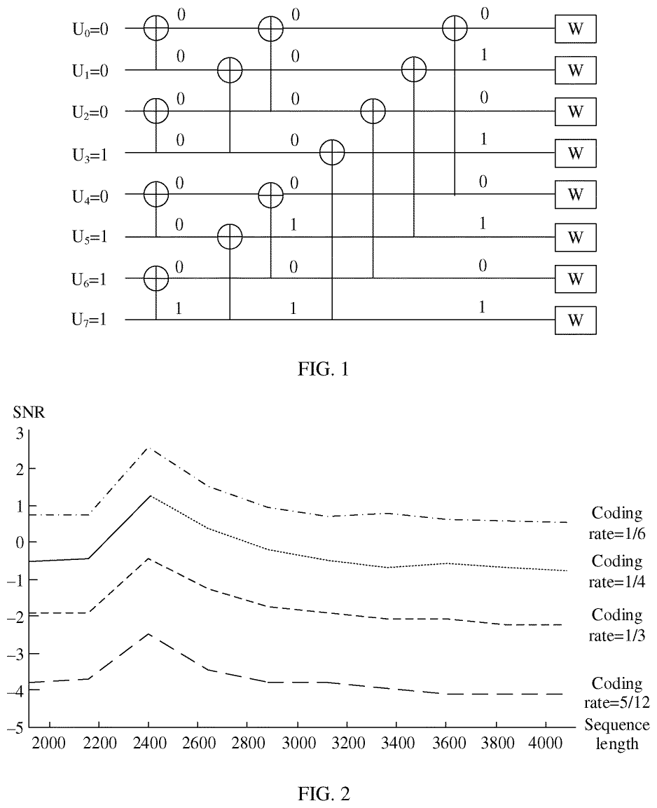

It can be learned that NAT puncturing is continuous puncturing, which reduces construction complexity. However, continuous puncturing easily causes a capacity change of the mother code, and a pit may occur at some positions. Consequently, this may affect communication efficiency. For example, as shown in FIG. 2, when the code length of the mother code is 2400 bits, NAT puncturing causes a performance pit region to occur, and a signal to interference plus noise ratio (SNR) is very high. This affects demodulation performance of a receiver, and consequently reduces communication efficiency.

### 3. NR Sub-Block Interleaving:

Rate matching of an NR polar code is corrected for NAT puncturing. In a puncturing mode, a mother code of the polar code is divided into 32 sub-blocks, and sub-block interleaving is performed in an order shown in Table 1.

TABLE 1

| i | P(i) |
|---|---|
| 0 | 0 |
| 1 | 1 |
| 2 | 2 |
| 3 | 4 |
| 4 | 3 |
| 5 | 5 |
| 6 | 6 |
| 7 | 7 |
| 8 | 8 |
| 9 | 16 |
| 10 | 9 |
| 11 | 17 |
| 12 | 10 |
| 13 | 18 |
| 14 | 11 |
| 15 | 19 |
| 16 | 12 |
| 17 | 20 |
| 18 | 13 |
| 19 | 21 |
| 20 | 14 |
| 21 | 22 |
| 22 | 15 |
| 22 | 23 |
| 24 | 24 |
| 25 | 25 |
| 26 | 26 |
| 27 | 28 |
| 28 | 27 |
| 29 | 29 |
| 30 | 30 |
| 31 | 31 |

In this way, if the to-be-sent sequence is a polar code with a code length being M, the code length of the mother code corresponding to the to-be-sent sequence is N, and N is greater than M, the transmitter may select, in the interleaving order shown in Table 1, the first N−M bit positions of the mother code as the puncturing positions, for example, a sub-block 0, a sub-block 1, a sub-block 2, a sub-block 4, or the like; or a sub-block 31, a sub-block 30, a sub-block 29, a sub-block 27, or the like. Details are not described again. In addition, in the puncturing mode, the transmitter may further additionally pre-freeze some bit positions based on N and M, to ensure that some positions whose capacities change greatly due to puncturing are not selected as information bit positions.

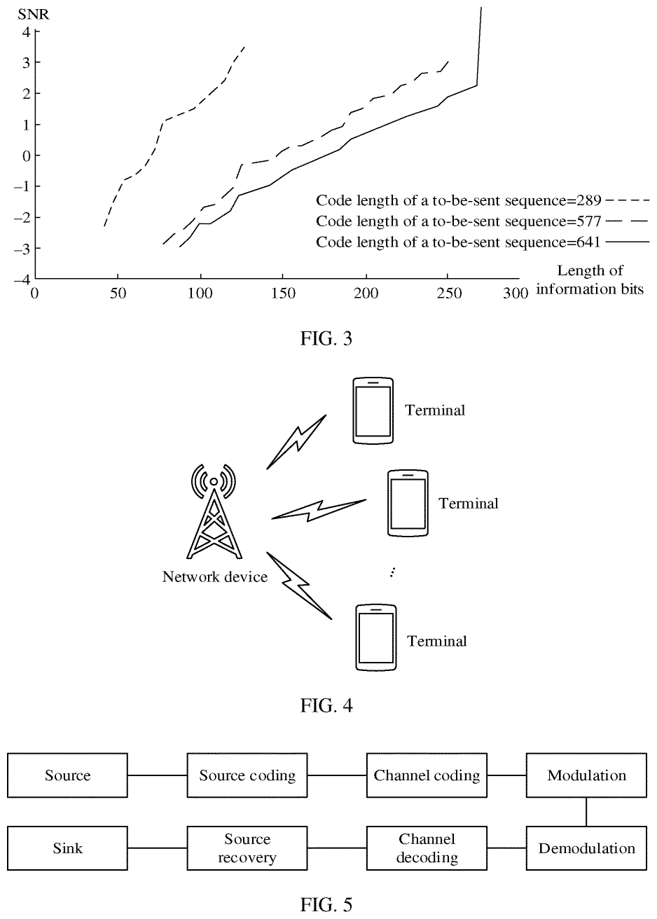

It can be learned that NR sub-block interleaving increases construction complexity, and rate matching is also more complex. In addition, NR sub-block interleaving still has a pit. For example, as shown in FIG. 3, if a code length M of a to-be-sent sequence is 641, K information bits include 250 data bits and 24 CRC bits, and a code rate is 0.446, puncturing positions are 0 to 319 and 512 to 574. In this case, a bit position 575 is selected as an information bit position, but it is actually found that a capacity of the bit position 575 is almost equal to 0, resulting in a performance pit. Consequently, an SNR required for normal communication is very high, and communication efficiency is reduced.

For the foregoing technical problems, embodiments of this application provide the following technical solutions.

The following describes technical solutions of this application with reference to the accompanying drawings.

The technical solutions in embodiments of this application may be applied to various communication systems, for example, a wireless network (Wi-Fi) system, a vehicle-to-everything (V2X) communication system, a device-to-device (D2D) communication system, an internet of vehicles communication system, a 4th generation (4G) mobile communication system such as a long term evolution ( ) system, a worldwide interoperability for microwave access (WiMAX) communication system, 5th generation (5G) such as a new radio (NR) system, and a future communication system.

In embodiments of this application, an “indication” may include a direct indication and an indirect indication, or may include an explicit indication and an implicit indication. Information indicated by a piece of information is referred to as to-be-indicated information. In a specific implementation process, the to-be-indicated information is indicated in a plurality of manners. By way of example and not limitation, the to-be-indicated information may be directly indicated. For example, the to-be-indicated information or an index of the to-be-indicated information is indicated. Alternatively, the to-be-indicated information may be indirectly indicated by indicating other information, and there is an association relationship between the other information and the to-be-indicated information. Alternatively, only a part of the to-be-indicated information may be indicated, and the other part of the to-be-indicated information is known or pre-agreed on. For example, specific information may alternatively be indicated by using an arrangement sequence of each piece of information that is pre-agreed on (for example, specified in a protocol), to reduce indication overheads to some extent. In addition, a common part of each piece of information may be further identified and then indicated in a unified manner, to reduce indication overheads caused by separately indicating same information.

Furthermore, specific indication manners may alternatively be various existing indication manners, for example, but not limited to, the foregoing indication manners and various combinations thereof. For specific details of the various indication manners, refer to the conventional technology. The details are not described again in this specification. It can be learned from the foregoing descriptions that, for example, when a plurality of pieces of information of a same type need to be indicated, different information may be indicated in different manners. In a specific implementation process, a required indication manner may be selected based on a specific requirement. The selected indication manner is not limited in embodiments of this application. In this way, the indication manner in embodiments of this application should be understood as covering various methods that can enable a to-be-indicated party to learn of to-be-indicated information.

It should be understood that the to-be-indicated information may be sent as a whole, or may be divided into a plurality of pieces of sub-information for separate sending. In addition, sending periodicities and/or sending occasions of the sub-information may be the same or different. A specific sending method is not limited in embodiments of this application. The sending periodicities and/or the sending occasions of the sub-information may be pre-defined, for example, pre-defined according to a protocol, or may be configured by a transmit end device by sending configuration information to a receive end device.

“Pre-definition” or “pre-configuration” may be implemented by pre-storing corresponding code or a corresponding table in a device, or may be implemented in another manner that may be used for indicating related information. A specific implementation thereof is not limited in embodiments of this application. “Storage” may be storage in one or more memories. The one or more memories may be separately disposed, or may be integrated into an encoder or a decoder, a processor, or a communication apparatus. Alternatively, some of the one or more memories may be separately disposed, and some of the one or more memories are integrated into a decoder, a processor, or a communication apparatus. A type of the memory may be a storage medium in any form. This is not limited in embodiments in this application.

The “protocol” in embodiments of this application may be a protocol family in the communication field, a standard protocol with a frame structure similar to a protocol family, or a related protocol applied to a future communication system. This is not specifically limited in embodiments of this application.

In embodiments of this application, descriptions such as “when . . . ”, “in a case of . . . ”, and “if” all mean that a device performs corresponding processing in a specific objective situation, and are not intended to limit time. The descriptions do not mean that the device is required to have a determining action during implementation, and do not mean any other limitation.

In descriptions of embodiments of this application, unless otherwise stated, “/” means an “or” relationship between associated objects, for example, A/B may represent A or B. In embodiments of this application, “and/or” describes only an association relationship between the associated objects, and indicates that three relationships may exist. For example, A and/or B may represent three cases: Only A exists, both A and B exist, and only B exists, where A and B may be singular or plural. In addition, in the descriptions of embodiments of this application, unless otherwise specified, “a plurality of” means two or more. “At least one of the following items (pieces)” or a similar expression thereof indicates any combination of these items, including a single item (piece) or any combination of a plurality of items (pieces). For example, at least one item (piece) of a, b, or c may indicate a, b, c, a and b, a and c, b and c, or a, b, and c, where a, b, and c may be singular or plural. In addition, to clearly describe the technical solutions in embodiments of this application, terms such as first and second are used in embodiments of this application to distinguish between same items or similar items that provide basically same functions or purposes. A person skilled in the art may understand that the terms such as “first” and “second” do not limit a quantity or an execution sequence, and the terms such as “first” and “second” do not indicate a definite difference. In addition, in embodiments of this application, terms such as “example” or “for example” are used to represent giving an example, an illustration, or a description. Any embodiment or design scheme described as an “example” or “for example” in embodiments of this application should not be explained as being more preferred or having more advantages than another embodiment or design scheme. Exactly, use of the terms such as “example” or “for example” is intended to present a related concept in a specific manner for ease of understanding.

A network architecture and a service scenario described in embodiments of this application are intended to describe the technical solutions in embodiments of this application more clearly, and do not constitute a limitation on the technical solutions provided in embodiments of this application. A person of ordinary skill in the art may know that with evolution of the network architecture and emergence of new service scenarios, the technical solutions provided in embodiments of this application are also applicable to similar technical problems.

For ease of understanding embodiments of this application, a communication system shown in FIG. 4 is first used as an example to describe in detail a communication system applicable to embodiments of this application. For example, FIG. 4 is a diagram of an architecture of a communication system to which a method is applicable according to an embodiment of this application.

As shown in FIG. 4, the communication system may include a plurality of communication apparatuses, for example, a first communication apparatus and a second communication apparatus.

The communication apparatus may be a terminal or a network device. For example, the first communication apparatus is a terminal, and the second communication apparatus is a network device; or the first communication apparatus is a network device, and the second communication apparatus is a terminal.

The terminal may also be referred to as user equipment (UE), an access terminal, a subscriber unit, a subscriber station, a mobile station (MS), a remote station, a remote terminal, a mobile device, a user terminal, a terminal device, a wireless communication device, a user agent, or a user apparatus. The terminal in embodiments of this application may be a mobile phone, a cellular phone, a smartphone, a tablet computer (Pad), a wireless data card, a personal digital assistant (PDA) computer, a wireless modem, a handheld device (handset), a laptop computer, a machine type communication (MTC) terminal, a computer having a wireless transceiver function, a virtual reality (VR) terminal, an augmented reality (AR) terminal, a smart home device (for example, a refrigerator, a television, an air conditioner, or an electricity meter), a smart robot, a robot arm, a workshop device, a wireless terminal in industrial control, a wireless terminal in self driving, a wireless terminal in remote medical, a wireless terminal in a smart grid, a wireless terminal in transportation safety, a wireless terminal in a smart city, a wireless terminal in a smart home, a vehicle-mounted terminal, a road side unit (RSU) or the like having a terminal function, a flight device (for example, a smart robot, a hot air balloon, an uncrewed aerial vehicle, or an airplane), or the like. The terminal in this application may alternatively be a vehicle-mounted module, a vehicle-mounted assembly, a vehicle-mounted part, a vehicle-mounted chip, or a vehicle-mounted unit that is disposed in a vehicle as one or more parts or units. Alternatively, the terminal may be another device that has a terminal function. For example, the terminal may alternatively be a device that functions as a terminal in D2D communication.

In embodiments of this application, a device form of the terminal is not limited. An apparatus configured to implement a function of the terminal may be the terminal, or may be an apparatus that can support the terminal in implementing the function, for example, a chip system. The apparatus may be installed in the terminal or used in cooperation with the terminal. In embodiments of this application, the chip system may include a chip, or may include a chip and another discrete device.

The network device may be a radio access network (RAN) device, which is also referred to as an access network apparatus. The access network apparatus may be specifically a next-generation mobile communication system, for example, a 6G access network device such as a 6G base station. Alternatively, in a next-generation mobile communication system, the access network apparatus may be named in another manner, which falls within the protection scope of embodiments of this application. This is not limited in this application. Alternatively, the access network apparatus may include a gNB in 5G, for example, a new radio (NR) system, may include one or a group of antenna panels (including a plurality of antenna panels) of a base station in 5G, or may be a network node that forms a gNB, atransmission and reception point (TRP), or transmission point (TP), or a transmission measurement function (TMF), for example, a central unit (CU), a distributed unit (DU), a CU-control plane (CP), or a CU-user plane (UP), a radio unit (RU), an RSU having a base station function, a wired access gateway, or a 5G core network element. Alternatively, the access network apparatus may further include an access point (AP) in a wireless fidelity (Wi-Fi) system, a wireless relay node, a wireless backhaul node, various forms of macro base stations, a micro base station (also referred to as a small cell), a relay station, an access point, a wearable device, a vehicle-mounted device, or the like.

The CU and the DU may be separately disposed, or may be included in a same network element, for example, a baseband unit (BBU). The RU may be included in a radio frequency device or a radio frequency unit, for example, included in a remote radio unit (RRU), an active antenna unit (AAU), or a remote radio head (RRH). It may be understood that the network device may be a CU node, a DU node, or a device including a CU node and a DU node. In addition, the CU may be classified as a network device in an access network RAN, or the CU may be classified as a network device in a core network CN. This is not limited herein.

In different systems, the CU (or the CU-CP and the CU-UP), the DU, or the RU may also have different names, but a person skilled in the art may understand meanings of the names. For example, in an ORAN system, the CU may also be referred to as an O-CU (open CU), the DU may also be referred to as an O-DU, the CU-CP may also be referred to as an O-CU-CP, the CU-UP may also be referred to as an O-CU-UP, and the RU may also be referred to as an O-RU. For ease of description, the CU, the CU-CP, the CU-UP, the DU, and the RU are used as examples for description in this application. Any unit in the CU (or the CU-CP or the CU-UP), the DU, and the RU in this application may be implemented by using a software module, a hardware module, or a combination of a software module and a hardware module.

The communication system in embodiments of this application is applicable to a coding scenario, and may be implemented by using a dedicated chip ASIC or a programmable chip FPGA, or may be implemented by using software (program code in a memory). As shown in FIG. 5, embodiments of this application mainly relate to channel coding. For other descriptions, refer to related descriptions in 3GPP. Details are not described herein again.

In the communication system, the first communication apparatus or the second communication apparatus divides a first bit sequence into Y sub-blocks, and punctures and/or shortens each sub-block, so that at least some bits (for example, Ai bits) of each sub-block can be discarded, and the discarded bits are relatively even. This does not affect the communication capacity, and no performance pit occurs, thereby ensuring communication efficiency.

In embodiments of this application, a device form of the network device is not limited. An apparatus configured to implement a function of the network device may be the network device, or may be an apparatus that can support the network device in implementing the function, for example, a chip system. The apparatus may be mounted in the network device or used in cooperation with the network device. In embodiments of this application, the chip system may include a chip, or may include a chip and another discrete device.

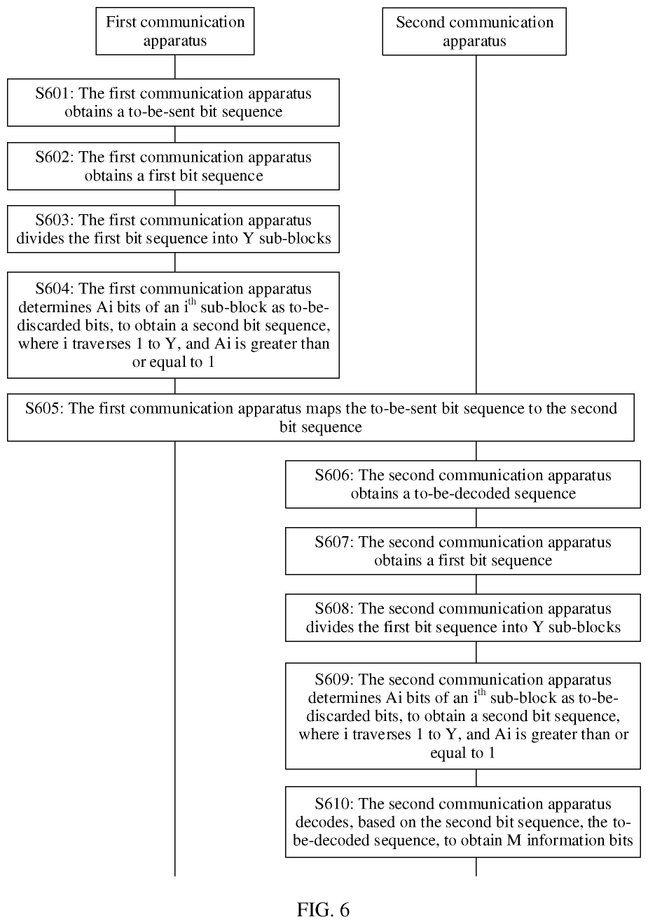

With reference to FIG. 6 to FIG. 8, the following specifically describes an interaction procedure between network elements/devices in the foregoing communication system by using method embodiments. The rate matching method provided in embodiments of this application may be applicable to the foregoing communication system. The following provides specific descriptions.

FIG. 6 is a schematic flowchart of a rate matching method according to an embodiment of this application. The rate matching method is applicable to the foregoing communication system, and mainly relates to interaction between a first communication apparatus and a second communication apparatus.

As shown in FIG. 6, a procedure of the rate matching method is as follows.
S601: The first communication apparatus obtains a to-be-sent bit sequence.

A length of the to-be-sent bit sequence may be M, where M is a positive integer. The to-be-sent bit sequence may include to-be-sent information, for example, K information bits, where K is a positive integer less than or equal to M. For example, a coding rate is R, a value of R is between 0 and 1, and M=K/R. In other words, the first communication apparatus may lengthen, based on the coding rate, a bit sequence of the to-be-sent information, to obtain the to-be-sent bit sequence. There are a plurality of manners in which the first communication apparatus obtains the to-be-sent information. For example, the to-be-sent information may be obtained based on a trigger condition (for example, a service needs to be established, or service data needs to be transmitted). For another example, the to-be-sent information may be obtained according to a protocol definition. This is not specifically limited herein.
S602: The first communication apparatus obtains a first bit sequence.

The first bit sequence may also be referred to as a mother code, and is used to transmit the to-be-sent bit sequence. A length of the first bit sequence may be N. For example, the first communication apparatus may determine, based on the length M of the to-be-sent bit sequence, that the length of the first bit sequence is N, for example, determine a calculation result of 2^{ceil(log 2(M)} as N, where M is less than N. For another example, if a calculation result of 2^{ceil(log 2(M)} is greater than Nmax, namely, a maximum value of a length of the mother code, the first communication apparatus may alternatively determine that the length of the first bit sequence is Nmax, namely, N=Nmax. In some cases, if the length of the first bit sequence is N/2 and N/2 is less than M, a subsequent procedure in this embodiment of this application is not performed.
S603: The first communication apparatus divides the first bit sequence into Y sub-blocks.

Y is an integer greater than 1, and a value of Y may be a power of 2, for example, 4, 8, 16, 32, or 64. This is not specifically limited. Each of the Y sub-blocks includes X bits, where X is an integer greater than 1. In other words, the first communication apparatus evenly divides the first bit sequence into the Y sub-blocks. A quantity of bits included in each sub-block may be as close as possible to or the same as a quantity of sub-blocks, that is, values of X and Y may be the same or similar, so that division into the sub-blocks may be more even, to avoid impact of shortening and/or puncturing on a communication capacity. For example, X=Y=8, that is, there are eight sub-blocks, and each sub-block includes 8 bits; or X=8 and Y=16, that is, there are 16 sub-blocks, and each sub-block includes 8 bits; or X=16 and Y=16, that is, there are 16 sub-blocks, and each sub-block includes 16 bits.
S604: The first communication apparatus determines Ai bits of an i^{th} sub-block as to-be-discarded bits, to obtain a second bit sequence, where i traverses 1 to Y, and Ai is greater than or equal to 1.

The to-be-discarded bit may include a to-be-shortened bit and/or a to-be-punctured bit. The to-be-shortened bit participates in encoding, but does not affect an encoding result. The to-be-punctured bit may be understood as being frozen, for example, being set to 0, and participates in encoding, and affects an encoding result. There are N−M to-be-discarded bits in the Y sub-blocks, for example, N−M=S. That is, a sum value of the to-be-discarded bits Ai in each of the Y sub-blocks is S.

The Ai bits of the i^{th} sub-block are Ai bits with largest indexes in the X bits of the i^{th} sub-block, or the Ai bits of the i^{th} sub-block are Ai bits with largest index reversal values in the X bits of the i^{th} sub-block. The index reversal value may be reversal of a binary expression of the index. For example, reversal of 110 is 011. It can be learned that the first communication apparatus selects the Ai bits as the to-be-discarded bits in descending order (or from back to front) of the indexes or the index reversal values. In comparison with an ascending order of the indexes or the index reversal values, this selection manner has small impact on a row weight, that is, has small impact on a code structure. This means that the to-be-discarded bits have small impact or almost no impact on the communication capacity, to avoid a decrease in communication efficiency due to occurrence of a pit region.

A minimum value of Ai may be denoted as Amin, and Amin is an integer greater than or equal to 1. In other words, at least one bit with a same index or a same index reversal value in each sub-block is determined as a to-be-discarded bit or a to-be-shortened bit. If the Y sub-blocks are considered as Y columns, and the X bits included in each sub-block are considered as X rows, the Y sub-blocks are interleaved, for example, in an interleaving order that is an order of the Y sub-blocks in the first bit sequence, to obtain a matrix with X rows and Y columns. Bits with a same index in each sub-block may be understood as one row of the matrix.

Correspondingly, Amin rows of bits in the matrix are determined as to-be-discarded bits, to implement relatively even shortening and avoid impact on the communication capacity.

Optionally, Amin may be a value obtained by rounding down (N−M)/Y. That is, when a quantity of bits that need to be discarded is N−M, several rows of bits in the matrix may be all discarded. Alternatively, Amin may be determined based on a value obtained by rounding down (N−M)/Y. For example, the value obtained by rounding down (N−M)/Y is A. If A is greater than or equal to a preset value, Amin is the preset value; or if A is less than the preset value, Amin is A. The preset value may indicate that at most a preset quantity of rows of bits in the matrix can be all discarded, to avoid a decrease in the communication capacity due to discarding too many rows as a whole.

In other words, the first communication apparatus may first determine Amin, and then determine, based on Amin, Amin bits with largest indexes or Amin bits with largest index reversal values in the Y sub-blocks as to-be-shortened bits.

For ease of understanding, an example is used for description.

If a length K of information bits is 28, namely, 28 information bits, and a coding rate R is 0.848, the length M of the to-be-sent bit sequence is 33; or if a length K of information bits is 14, namely, 14 information bits, and a coding rate R is 0.424, the length M of the to-be-sent bit sequence is 33. In this case, 2^{ceil(log 2(33))}=N=64. In other words, the first bit sequence with a length of 64 bits is selected as the mother code. N−M=S=31 indicates that 31 bits in the first bit sequence need to be determined as to-be-discarded bits in this case.

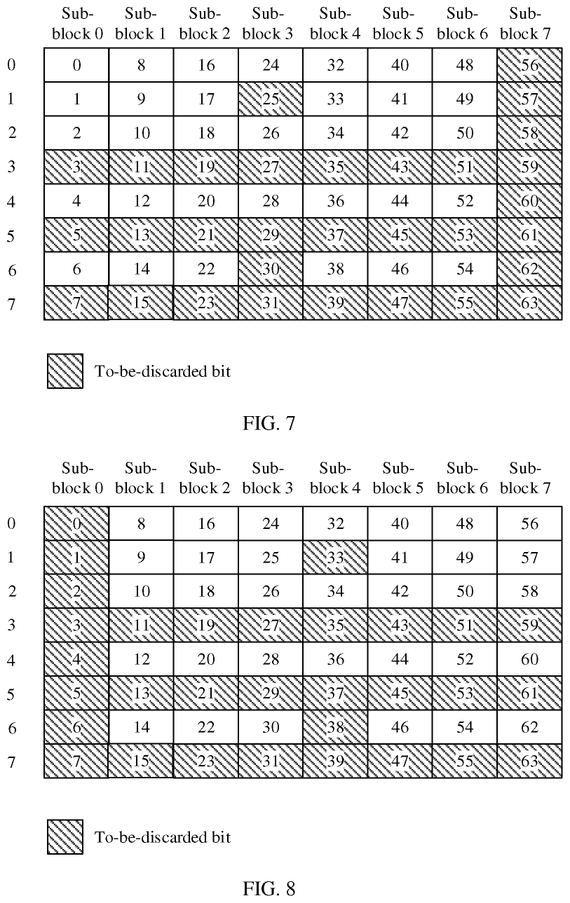

Y=8 is set, the first communication apparatus divides the first bit sequence into eight sub-blocks, and each sub-block includes 8 bits, namely, X=8. As shown in FIG. 7 or FIG. 8, the first communication apparatus interleaves the eight sub-blocks to obtain an 8*8 matrix. The first communication apparatus determines, based on Amin=floor(31/8)=3, that there are three rows of bits that need to be determined as to-be-shortened bits, where floor( ) indicates rounding down. Indexes of the 8 bits included in each sub-block may be indicated by 3 bits, for example, 000, 001, 010, 011, 100, 101, 110, and 111. 111 represents 7, that is, a bit with an 8th smallest index, namely, a 7th row of the matrix; 110 represents 6, that is, a bit with a 7^{th} smallest index, namely, a 6^{th} row of the matrix; and so on. 000 represents 0, that is, a bit with a 1^{st} smallest index, namely, a 0^{th} row of the matrix. As shown in FIG. 7 or FIG. 8, after the index is reversed, an index reversal value of the index 011 of a 3^{rd} row is expressed as 110, that is, the reversal indicates 6. Therefore, Amin=3 is set, and three rows with largest index reversal values include the 3^{rd} row, a 5^{th} row, and the 7^{th} row. Therefore, the first communication apparatus determines that to-be-shortened rows are the 3^{rd} row, the 5^{th} row, and the 7^{th} row; or a 3^{rd} bit, a 5^{th} bit, and a 7^{th} bit in each sub-block are to-be-shortened bits.

Optionally, if B=(N−M)−Amin*Y and B is a positive integer, it indicates that B bits still need to be discarded after complete Amin rows are discarded. Therefore, the first communication apparatus may continue to select B bits from Z sub-blocks of the Y sub-blocks as to-be-discarded bits, to ensure that all redundant bits can be finally discarded. Z is a positive integer less than Y in most cases, but this is not limited. Z may alternatively be equal to Y, and Z is a value obtained by rounding up B/(X−A), or may be determined in any other possible manner. This is not limited herein.

For example, the first communication apparatus may obtain a value of Z by rounding up B/(X−A). Then, the first communication apparatus may select Z sub-blocks from the Y sub-blocks based on the coding rate. Specifically, if the coding rate is less than or equal to a code rate threshold, the Z sub-blocks are Z sub-blocks with smallest indexes in the Y sub-blocks, or the Z sub-blocks are Z sub-blocks with smallest index reversal values in the Y sub-blocks. In other words, the first communication apparatus may select Z sub-blocks from the Y sub-blocks in ascending order of indexes or index reversal values. If the coding rate is greater than the code rate threshold, the Z sub-blocks are Z sub-blocks with largest indexes in the Y sub-blocks, or the Z sub-blocks are Z sub-blocks with largest index reversal values in the Y sub-blocks. In other words, the first communication apparatus may select Z sub-blocks from the Y sub-blocks in descending order of indexes or index reversal values. Certainly, the first communication apparatus may alternatively select Z sub-blocks with smallest indexes or smallest index reversal values by default, or select Z sub-blocks with largest indexes or largest index reversal values by default. This is not limited herein.

It may be understood that the Z sub-blocks are selected in ascending order when the coding rate is low, or the Z sub-blocks are selected in descending order when the coding rate is high. In this way, impact of the selected to-be-discarded bits on the communication capacity can be avoided, thereby avoiding a decrease in communication efficiency and ensuring communication stability.

When the Z sub-blocks are determined, the first communication apparatus may determine to-be-discarded bits in each sub-block. For example, for a j^{th} sub-block in the Z sub-blocks, the j^{th} sub-block has Amin+Dj to-be-discarded bits, where j traverses 1 to Z, and a sum of D1, D2, . . . , and Dz is B. When Z is greater than 1, X bits of each Z−1 sub-blocks in the Z sub-blocks are all to-be-discarded bits.

For example, when the Z sub-blocks are Z sub-blocks with smallest indexes in the Y sub-blocks, the Z−1 sub-blocks are Z−1 sub-blocks with smallest indexes in the Z sub-blocks. Alternatively, when the Z sub-blocks are Z sub-blocks with smallest index reversal values in the Y sub-blocks, the Z−1 sub-blocks are Z−1 sub-blocks with smallest index reversal values in the Z sub-blocks. In other words, the first communication apparatus may select Z−1 sub-blocks with smallest indexes or smallest index reversal values from the Z sub-blocks, and determine remaining X−Amin bits that are not discarded and that are of each of the Z−1 sub-blocks as to-be-discarded bits or to-be-punctured bits.

For another example, when the Z sub-blocks are Z sub-blocks with largest indexes in the Y sub-blocks, the Z−1 sub-blocks are Z−1 sub-blocks with largest indexes in the Z sub-blocks. Alternatively, when the Z sub-blocks are Z sub-blocks with largest index reversal values in the Y sub-blocks, the Z−1 sub-blocks are Z−1 sub-blocks with largest index reversal values in the Z sub-blocks. Similarly, alternatively, the first communication apparatus may select Z−1 sub-blocks with largest indexes or largest index reversal values from the Z sub-blocks, and determine remaining X−Amin bits that are not discarded and that are of each of the Z−1 sub-blocks as to-be-discarded bits or to-be-shortened bits.

A last sub-block other than the Z−1 sub-blocks in the Z sub-blocks is denoted as a sub-block z. There are Amin+Dz to-be-discarded bits in the sub-block z, where Dz is B−[(Z−1)*(X−Amin)]. Dz to-be-discarded bits are Dz bits with largest indexes or largest index reversal values in X bits excluding Amin to-be-discarded bits. In other words, the first communication apparatus may select the Dz bits with the largest indexes or the largest index reversal values from the X−Amin bits of the sub-block z as to-be-discarded bits, to ensure that all redundant S bits can be finally discarded.

It may be understood that the foregoing is some implementations of the Z sub-blocks, and imposes no limitation. For example, alternatively, the Z sub-blocks may be Z sub-blocks with lowest reliability in the Y sub-blocks, and the Z−1 sub-blocks are Z−1 sub-blocks with lowest reliability in the Z sub-blocks. Alternatively, the Z sub-blocks may be Z sub-blocks with highest reliability in the Y sub-blocks, and the Z−1 sub-blocks are Z−1 sub-blocks with highest reliability in the Z sub-blocks. It may be understood that reliability of a sub-block may be represented by reliability of any bit (for example, a 1^{st} bit) of the sub-block, or may be an average reliability value of at least some bits in the sub-block.

For ease of understanding, the foregoing example is further described.

As shown in FIG. 7, B=(64−33)−3*8=7, and Z=ceil(7/(8−3))=2, where ceil( ) indicates rounding up. The first communication apparatus selects two sub-blocks with largest index reversal values in the Y sub-blocks because the coding rate R=0.848 is greater than the code rate threshold, for example, 7/16. For example, indexes of eight sub-blocks may be indicated by 3 bits, for example, 000, 001, 010, 011, 100, 101, 110, and 111. 111 represents 7, that is, a sub-block with an 8^{th} smallest index, namely, a 7^{th} column of the matrix; 110 represents 6, that is, a sub-block with a 7^{th} smallest index, namely, a 6^{th} column of the matrix; and so on. 000 represents 0, that is, a sub-block with a 1^{st} smallest index, namely, a 0^{th} column of the matrix. For the Z−1 sub-blocks, alternatively, a sub-block with a largest index reversal value is a 7^{th} sub-block (where reversal of 111 is 111), namely, the 7^{th} column of the matrix. The first communication apparatus determines remaining 5 bits in the 7^{th} sub-block as to-be-shortened bits, for example, a bit 0, a bit 1, a bit 2, a bit 4, and a bit 6. For the Z sub-block, alternatively, a sub-block with a 2^{nd} largest index reversal value is a 3^{rd} sub-block (where reversal of 011 is 110), namely, a 3^{rd} column of the matrix. The first communication apparatus may determine 2 bits with largest index reversal values in remaining 5 bits of the 3^{rd} sub-block as to-be-shortened bits, for example, a bit 1 (where reversal of 001 is 100) and a bit 6 (where reversal of 101 is 101).

As shown in FIG. 8, B=(64−33)−3*8=7, and Z=ceil(7/(8−3))=2, where ceil( ) indicates rounding up. The first communication apparatus selects two sub-blocks with largest index reversal values in the Y sub-blocks because the coding rate R=0.424 is less than the code rate threshold. For example, for the Z−1 sub-blocks, alternatively, a sub-block with a smallest index reversal value is a 0^{th} sub-block (where reversal of 000 is 000), namely, a 0^{th} column of the matrix. The first communication apparatus determines remaining 5 bits in the 0^{th} sub-block as to-be-punctured bits, for example, a bit 0, a bit 1, a bit 2, a bit 4, and a bit 6. For the Z sub-block, alternatively, a sub-block with a 2^{nd} smallest index reversal value is a 4^{th} sub-block (where reversal of 100 is 001), namely, a 4^{th} column of the matrix. The first communication apparatus may determine 2 bits with largest index reversal values in remaining 5 bits of the 4^{th} sub-block as to-be-punctured bits, for example, a bit 1 (where reversal of 001 is 100) and a bit 6 (where reversal of 101 is 101).

It can be learned from the figure that the to-be-discarded bits selected in the foregoing manner are usually located at an edge of an X*Y matrix, and may be understood as selection from outside to inside, so that bits that are not discarded are relatively centralized and even. In this way, impact on the communication capacity can be avoided, thereby avoiding a decrease in communication efficiency.

It should be understood that the foregoing selection manner is merely an example. For example, when Y=32, the first communication apparatus may alternatively select Z sub-blocks in an order of interleaving 32 sub-blocks in current NR or select Z sub-blocks in any possible manner. This is not limited herein. For another example, the first communication apparatus may alternatively select the Dz bits in ascending order of the indexes or the index reversal values.

It may be further understood that the foregoing manner of selecting the to-be-discarded bits is merely some examples. For example, the Ai bits of the i^{th} sub-block may alternatively be Ai bits with highest reliability in the X bits of the i^{th} sub-block. Optionally, the first communication apparatus may sort the X bits of the i^{th} sub-block in descending order (or in ascending order) of reliability, and select Ai bits with highest reliability as to-be-discarded bits in the i^{th} sub-block. Alternatively, optionally, the first communication apparatus may sort N bits in the first bit sequence in descending order of reliability, and select S (N−M=S) bits with highest reliability as to-be-discarded bits. In this case, the i^{th} sub-block has Ai bits as to-be-discarded bits.
S605: The first communication apparatus maps the to-be-sent bit sequence to the second bit sequence.

The first communication apparatus may map (or fill) the K information bits in the to-be-sent bit sequence to the second bit sequence one by one in descending order of reliability of bits that are not discarded in the second bit sequence, to obtain a third bit sequence. In this way, the first communication apparatus may send the third bit sequence to the second communication apparatus.

For ease of understanding, the foregoing example is further described.

As shown in FIG. 7, in descending order of reliability of bits that are not discarded, 28 information bits may be respectively mapped to the bit 6, a bit 9, a bit 10, a bit 12, a bit 14, a bit 16, a bit 17, a bit 18, a bit 20, a bit 22, a bit 24, a bit 26, a bit 28, a bit 32, a bit 33, a bit 34, a bit 36, a bit 38, a bit 40, a bit 41, a bit 42, a bit 44, a bit 46, a bit 48, a bit 49, a bit 50, a bit 52, and a bit 54.

As shown in FIG. 8, in descending order of reliability of bits that are not discarded, 14 information bits may be respectively mapped to a bit 28, a bit 30, a bit 42, a bit 44, a bit 46, a bit 49, a bit 50, a bit 52, a bit 54, a bit 56, a bit 57, a bit 58, a bit 60, and a bit 62.
S606: The second communication apparatus obtains to-be-decoded information.

The to-be-decoded information may be a symbol sequence received by the second communication apparatus after the third bit sequence is modulated and sent by the first communication apparatus.
S607: The second communication apparatus obtains a first bit sequence.
S608: The second communication apparatus divides the first bit sequence into Y sub-blocks.
S609: The second communication apparatus determines Ai bits of an i^{th} sub-block as to-be-discarded bits, to obtain a second bit sequence, where i traverses 1 to Y, and Ai is greater than or equal to 1.

The length of the first bit sequence is N, and N is a positive integer. Each of the Y sub-blocks includes the X bits, and X and Y are integers greater than 1. Specific implementation principles of S607 to S609 are similar to those of S602 to S604. For details, refer to the related descriptions of S602 to S604 for understanding. Details are not described herein again.
S610: The second communication apparatus decodes, based on the second bit sequence, the to-be-decoded information, to obtain M information bits.

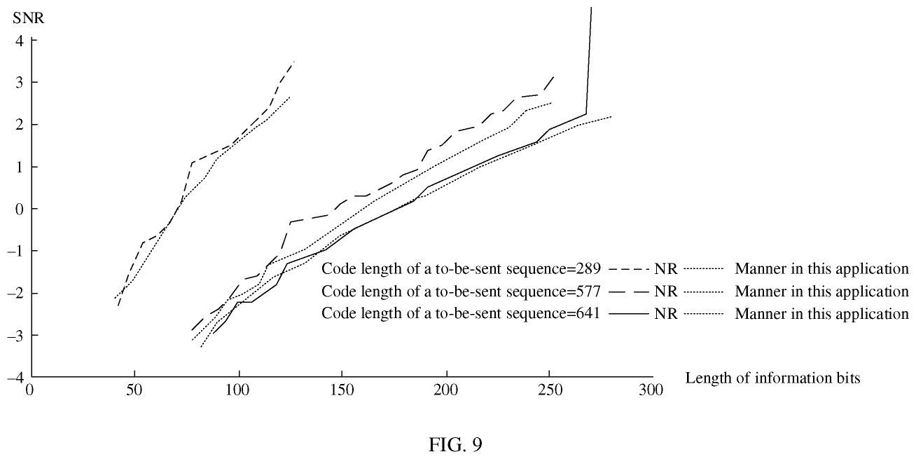

As shown in FIG. 9, on a basis of FIG. 3, rate matching is performed in the manner in this application, and stability of rate matching is better than that of NR. That is, a curve is smooth, and no sharp increase of a pit region occurs.

In conclusion, the first bit sequence is divided into the Y sub-blocks, and each sub-block is punctured and/or shortened, so that at least some bits (for example, Ai bits) of each sub-block can be discarded, and the discarded bits are relatively even. This reduces impact on the communication capacity, and reduces a possibility of occurrence of a performance pit, thereby ensuring communication efficiency.

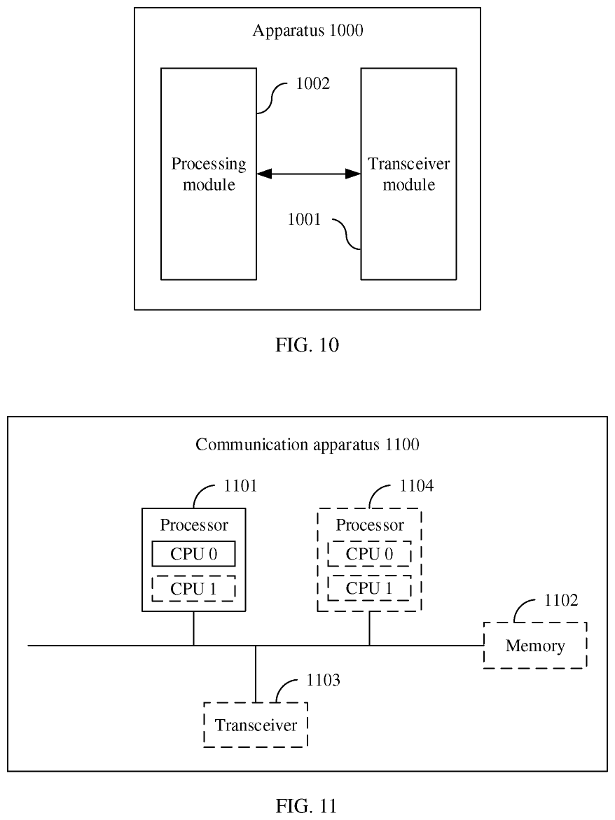

The foregoing describes in detail, with reference to FIG. 6 to FIG. 9, the methods provided in embodiments of this application. The following describes in detail, with reference to FIG. 10 and FIG. 11, a communication apparatus configured to perform the rate matching method provided in embodiments of this application.

FIG. 10 is a diagram 1 of a structure of a communication apparatus according to an embodiment of this application. For example, as shown in FIG. 10, the communication apparatus 1000 includes a transceiver module 1001 and a processing module 1002. For ease of description, FIG. 10 shows only main parts of the communication apparatus.

The transceiver module 1001 is configured to perform receiving and sending functions in the method shown in FIG. 6, and the processing module 1002 is configured to perform a function in the method shown in FIG. 6 other than the receiving and sending functions.

Optionally, the transceiver module 1001 may include a sending module (not shown in FIG. 10) and a receiving module (not shown in FIG. 10). The sending module is configured to implement a sending function of the communication apparatus 1000, and the receiving module is configured to implement a receiving function of the communication apparatus 1000.

Optionally, the communication apparatus 1000 may further include a storage module (not shown in FIG. 10), and the storage module stores a program or instructions. When the processing module 1002 executes the program or the instructions, the communication apparatus 1000 is caused to perform a function of the terminal or the network device in the method shown in FIG. 6.

It may be understood that the communication apparatus 1000 may be a terminal or a network device, may be a chip (system) or another part or component that may be disposed in a terminal or a network device, or may be an apparatus that includes a terminal or a network device. This is not limited in this application.

In addition, for technical effects of the communication apparatus 1000, refer to the technical effects of the rate matching method shown in FIG. 6 to FIG. 9. Details are not described herein again.

FIG. 11 is a diagram 2 of a structure of a communication apparatus according to an embodiment of this application. For example, the communication apparatus may be a terminal, or may be a chip (system) or another part or component that may be disposed in a terminal. As shown in FIG. 11, the communication apparatus 1100 may include a processor 1101. Optionally, the communication apparatus 1100 may further include a memory 1102 and/or a transceiver 1103. The processor 1101 is coupled to the memory 1102 and the transceiver 1103, for example, may be connected through a communication bus.

The following describes parts of the communication apparatus 1100 in detail with reference to FIG. 11.

The processor 1101 is a control center of the communication apparatus 1100, and may be a processor, or may be a generic term of a plurality of processing elements. For example, the processor 1101 is one or more central processing units (CPUs), or may be an application-specific integrated circuit (ASIC), or is configured as one or more integrated circuits that implement embodiments of this application, for example, one or more microprocessors (DSPs), or one or more field programmable gate arrays (FPGAs).

Optionally, the processor 1101 may perform various functions of the communication apparatus 1100 by running or executing a software program stored in the memory 1102 and invoking data stored in the memory 1102, for example, perform the rate matching method shown in FIG. 6.

During specific implementation, in an embodiment, the processor 1101 may include one or more CPUs, for example, a CPU 0 and a CPU 1 shown in FIG. 11.

During specific implementation, in an embodiment, the communication apparatus 1100 may alternatively include a plurality of processors, for example, the processor 1101 and a processor 1104 shown in FIG. 11. Each of the processors may be a single-core processor (single-CPU), or may be a multi-core processor (multi-CPU). The processor herein may be one or more devices, circuits, and/or processing cores configured to process data (for example, computer program instructions).

The memory 1102 is configured to store the software program for performing the solutions of this application, and the processor 1101 controls the execution. For a specific implementation, refer to the foregoing method embodiments. Details are not described herein again.

Optionally, the memory 1102 may be a read-only memory (ROM) or another type of static storage device that may store static information and instructions, or a random access memory (RAM) or another type of dynamic storage device that may store information and instructions, or may be an electrically erasable programmable read-only memory (EEPROM), a compact disc read-only memory (CD-ROM) or another compact disc storage, an optical disc storage (including a compact disc, a laser disc, an optical disc, a digital versatile disc, a Blu-ray disc, or the like), a magnetic disk storage medium or another magnetic storage device, or any other medium that can be used for carrying or storing expected program code in a form of instructions or a data structure and can be accessed by a computer, but is not limited thereto. The memory 1102 may be integrated with the processor 1101, or may exist independently and is coupled to the processor 1101 through an interface circuit (not shown in FIG. 11) of the communication apparatus 1100. This is not specifically limited in embodiments of this application.

The transceiver 1103 is configured to communicate with another communication apparatus. For example, the communication apparatus 1100 is a terminal, and the transceiver 1103 may be configured to communicate with a network device or communicate with another terminal device. For another example, the communication apparatus 1100 is a network device, and the transceiver 1103 may be configured to communicate with a terminal or communicate with another network device.

Optionally, the transceiver 1103 may include a receiver and a transmitter (not separately shown in FIG. 11). The receiver is configured to implement a receiving function, and the transmitter is configured to implement a sending function.

Optionally, the transceiver 1103 may be integrated with the processor 1101, or may exist independently and is coupled to the processor 1101 through an interface circuit (not shown in FIG. 11) of the communication apparatus 1100. This is not specifically limited in embodiments of this application.

It may be understood that the structure of the communication apparatus 1100 shown in FIG. 11 does not constitute a limitation on the communication apparatus. An actual communication apparatus may include more or fewer parts than those shown in the figure, combine some parts, or have different part arrangement.

In addition, for technical effects of the communication apparatus 1100, refer to the technical effects of the method in the foregoing method embodiments. Details are not described herein again.

It should be understood that the processor in embodiments of this application may be a central processing unit (CPU), or the processor may be another general-purpose processor, a digital signal processor (DSP), an application-specific integrated circuit (ASIC), a field programmable gate array (FPGA) or another programmable logic device, a discrete gate or transistor logic device, a discrete hardware component, or the like. The general-purpose processor may be a microprocessor, or the processor may be any conventional processor or the like.

It may be understood that the memory in embodiments of this application may be a volatile memory or a non-volatile memory, or may include a volatile memory and a non-volatile memory. The non-volatile memory may be a read-only memory (ROM), a programmable read-only memory (PROM), an erasable programmable read-only memory (EPROM), an electrically erasable programmable read-only memory (EEPROM), or a flash memory. The volatile memory may be a random access memory (RAM), and is used as an external cache. Through an example rather than a limitative description, random access memories (RAMs) in many forms may be used, for example, a static random access memory (SRAM), a dynamic random access memory (DRAM), a synchronous dynamic random access memory (SDRAM), a double data rate synchronous dynamic random access memory (DDR SDRAM), an enhanced synchronous dynamic random access memory (ESDRAM), a synchlink dynamic random access memory (SLDRAM), and a direct rambus random access memory (DR RAM).

All or some of the foregoing embodiments may be implemented using software, hardware (for example, a circuit), firmware, or any combination thereof. When software is used to implement embodiments, the foregoing embodiments may be implemented completely or partially in a form of a computer program product. The computer program product includes one or more computer instructions or computer programs. When the computer instructions or the computer programs are loaded and executed on a computer, the procedure or functions according to embodiments of this application are all or partially generated. The computer may be a general-purpose computer, a dedicated computer, a computer network, or another programmable apparatus. The computer instructions may be stored in a computer-readable storage medium or may be transmitted from a computer-readable storage medium to another computer-readable storage medium. For example, the computer instructions may be transmitted from a website, computer, server, or data center to another website, computer, server, or data center in a wired (for example, infrared, radio, or microwave) manner. The computer-readable storage medium may be any usable medium accessible by a computer, or a data storage device, such as a server or a data center, integrating one or more usable media. The usable medium may be a magnetic medium (for example, a floppy disk, a hard disk, or a magnetic tape), an optical medium (for example, a DVD), or a semiconductor medium. The semiconductor medium may be a solid-state drive.

It should be understood that the term “and/or” in this specification describes only an association relationship between associated objects and represents that three relationships may exist. For example, A and/or B may represent the following three cases: only A exists, both A and B exist, and only B exists. A and B may be singular or plural. In addition, the character “/” in this specification usually indicates an “or” relationship between the associated objects, but may also indicate an “and/or” relationship. For details, refer to the context for understanding.

In this application, “at least one” means one or more, and “a plurality of” means two or more. “At least one of the following items (pieces)” or a similar expression thereof indicates any combination of these items, including a single item (piece) or any combination of a plurality of items (pieces). For example, at least one of a, b, or c may indicate a, b, c, a and b, a and c, b and c, or a, b, and c, where a, b, and c may be singular or plural.

It should be understood that sequence numbers of the foregoing processes do not mean execution sequences in various embodiments of this application. The execution sequences of the processes should be determined according to functions and internal logic of the processes, and should not be construed as any limitation on the implementation processes of embodiments of this application.

A person of ordinary skill in the art may be aware that, in combination with the examples described in embodiments disclosed in this specification, units and algorithm steps may be implemented by electronic hardware or a combination of computer software and electronic hardware. Whether the functions are performed by hardware or software depends on particular applications and design constraints of the technical solutions. A person skilled in the art may use different methods to implement the described functions for each particular application, but it should not be considered that the implementation goes beyond the scope of this application.

It may be clearly understood by a person skilled in the art that, for the purpose of convenient and brief description, for a detailed working process of the foregoing system, apparatus, and unit, refer to a corresponding process in the foregoing method embodiments. Details are not described herein again.

In the several embodiments provided in this application, it should be understood that the disclosed system, apparatus, and method may be implemented in other manners. For example, the described apparatus embodiments are merely examples. For example, division into the units is merely logical function division and may be other division during actual implementation. For example, a plurality of units or components may be combined or integrated into another system, or some features may be ignored or not performed. In addition, the displayed or discussed mutual couplings or direct couplings or communication connections may be implemented through some interfaces. The indirect couplings or communication connections between the apparatuses or units may be implemented in electronic, mechanical, or other forms.

The units described as separate parts may or may not be physically separate, and parts displayed as units may or may not be physical units, may be located in one position, or may be distributed on a plurality of network units. Some or all of the units may be selected based on actual requirements to achieve the objectives of the solutions of embodiments.

In addition, functional units in embodiments of this application may be integrated into one processing unit, each of the units may exist alone physically, or two or more units are integrated into one unit.

When the functions are implemented in a form of a software functional unit and sold or used as an independent product, the functions may be stored in a computer-readable storage medium. Based on such an understanding, the technical solutions of this application essentially, the part contributing to the conventional technology, or a part of the technical solutions may be implemented in a form of a software product. The computer software product is stored in a storage medium, and includes several instructions for enabling a computer device (which may be a personal computer, a server, a network device, or the like) to perform all or some of the steps of the methods described in embodiments of this application. The foregoing storage medium includes any medium that can store program code, such as a USB flash drive, a removable hard disk, a read-only memory (ROM), a random access memory (RAM), a magnetic disk, or an optical disc.

The foregoing descriptions are merely specific implementations of this application, but are not intended to limit the protection scope of this application. Any variation or replacement readily figured out by a person skilled in the art within the technical scope disclosed in this application shall fall within the protection scope of this application. Therefore, the protection scope of this application shall be subject to the protection scope of the claims.

What is claimed is:

1. A bit mapping method, comprising:
obtaining a to-be-sent bit sequence, wherein a length of the to-be-sent bit sequence is M, and M is a positive integer;
obtaining a first bit sequence, wherein a length of the first bit sequence is N, N is a positive integer, and M is less than N;
dividing the first bit sequence into Y sub-blocks, wherein each of the Y sub-blocks comprises X bits, and X and Y are integers greater than 1;
determining Ai bits of an i^{th} sub-block as to-be-discarded bits, to obtain a second bit sequence, wherein i traverses 1 to Y, Ai is greater than or equal to 1, and there are N−M to-be-discarded bits in the Y sub-blocks; and
mapping the to-be-sent bit sequence to the second bit sequence.

2. The method according to claim 1, wherein the Ai bits of the i^{th} sub-block are Ai bits with largest indexes in the X bits of the i^{th} sub-block, or the Ai bits of the i^{th} sub-block are Ai bits with largest index reversal values in the X bits of the i^{th} sub-block, or the Ai bits of the i^{th} sub-block are Ai bits with highest reliability in the X bits of the i^{th} sub-block.

3. The method according to claim 1, wherein a minimum value of Ai is Amin, and Amin is determined based on a value obtained by rounding down (N−M)/Y.

4. The method according to claim 3, wherein the value obtained by rounding down (N−M)/Y is A, the Amin is determined based on a value obtained by rounding down (N−M)/Y comprise:
Amin is A; or
the Amin is determined based on a value obtained by rounding down (N−M)/Y comprise: if A is greater than or equal to a preset value, Amin is the preset value, if A is less than the preset value, Amin is A.

5. The method according to claim 3, wherein if B=(N−M)−Amin*Y and B is a positive integer, in Z sub-blocks of the Y sub-blocks, a j^{th} sub-block has Amin+Dj to-be-discarded bits, wherein Z is a positive integer less than or equal to Y, j traverses 1 to Z, and a sum of D1 to Dz is B.

6. The method according to claim 5, wherein when Z is greater than 1, X bits of each Z−1 sub-blocks in the Z sub-blocks are all to-be-discarded bits.

7. The method according to claim 6, wherein
when the Z sub-blocks are Z sub-blocks with smallest indexes in the Y sub-blocks, the Z−1 sub-blocks are Z−1 sub-blocks with smallest indexes in the Z sub-blocks; or
when the Z sub-blocks are Z sub-blocks with smallest index reversal values in the Y sub-blocks, the Z−1 sub-blocks are Z−1 sub-blocks with smallest index reversal values in the Z sub-blocks.

8. The method according to claim 6, wherein
when the Z sub-blocks are Z sub-blocks with largest indexes in the Y sub-blocks, the Z−1 sub-blocks are Z−1 sub-blocks with largest indexes in the Z sub-blocks; or
when the Z sub-blocks are Z sub-blocks with largest index reversal values in the Y sub-blocks, the Z−1 sub-blocks are Z−1 sub-blocks with largest index reversal values in the Z sub-blocks.

9. The method according to claim 5, wherein
if a coding rate is less than or equal to a code rate threshold, the Z sub-blocks are Z sub-blocks with smallest indexes in the Y sub-blocks, or the Z sub-blocks are Z sub-blocks with smallest index reversal values in the Y sub-blocks; or
if a coding rate is greater than the code rate threshold, the Z sub-blocks are Z sub-blocks with largest indexes in the Y sub-blocks, or the Z sub-blocks are Z sub-blocks with largest index reversal values in the Y sub-blocks.

10. The method according to claim 5, wherein Z is a value obtained by rounding up B/(X−A).

11. A rate matching method, comprising:
obtaining to-be-decoded information;
obtaining a first bit sequence, wherein a length of the first bit sequence is N, and N is a positive integer;
dividing the first bit sequence into Y sub-blocks, wherein each of the Y sub-blocks comprises X bits, and X and Y are integers greater than 1;
determining Ai bits of an i^{th} sub-block as to-be-discarded bits, to obtain a second bit sequence, wherein i traverses 1 to Y, Ai is greater than or equal to 1, and there are N−M to-be-discarded bits in the Y sub-blocks; and
decoding, based on the second bit sequence, the to-be-decoded information, to obtain M information bits, wherein M is a positive integer less than N.

12. The method according to claim 11, wherein the Ai bits of the i^{th} sub-block are Ai bits with largest indexes in the X bits of the i^{th} sub-block, or the Ai bits of the i^{th} sub-block are Ai bits with largest index reversal values in the X bits of the i^{th} sub-block, or the Ai bits of the i^{th} sub-block are Ai bits with highest reliability in the X bits of the i^{th} sub-block.

13. The method according to claim 11, wherein a minimum value of Ai is Amin, and Amin is determined based on a value obtained by rounding down (N−M)/Y.

14. The method according to claim 13, wherein the value obtained by rounding down (N−M)/Y is A, the Amin is determined based on a value obtained by rounding down (N−M)/Y comprise:
Amin is A; or
the Amin is determined based on a value obtained by rounding down (N−M)/Y comprise: if A is greater than or equal to a preset value, Amin is the preset value, if A is less than the preset value, Amin is A.

15. The method according to claim 13, wherein if B=(N−M)−Amin*Y and B is a positive integer, in Z sub-blocks of the Y sub-blocks, a j^{th} sub-block has Amin+Dj to-be-discarded bits, wherein Z is a positive integer less than or equal to Y, j traverses 1 to Z, and a sum of D1 to Dz is B.

16. The method according to claim 15, wherein when Z is greater than 1, X bits of each Z−1 sub-blocks in the Z sub-blocks are all to-be-discarded bits.

17. The method according to claim 15, wherein
if a coding rate is less than or equal to a code rate threshold, the Z sub-blocks are Z sub-blocks with smallest indexes in the Y sub-blocks, or the Z sub-blocks are Z sub-blocks with smallest index reversal values in the Y sub-blocks; or
if a coding rate is greater than the code rate threshold, the Z sub-blocks are Z sub-blocks with largest indexes in the Y sub-blocks, or the Z sub-blocks are Z sub-blocks with largest index reversal values in the Y sub-blocks.

18. The method according to claim 15, wherein Z is a value obtained by rounding up B/(X−A).

19. A communication apparatus, comprising a processor, the processor is configured to, when executing the programming instructions, enable the communication apparatus to:
obtain a to-be-sent bit sequence, wherein a length of the to-be-sent bit sequence is M, and M is a positive integer;
obtain a first bit sequence, wherein a length of the first bit sequence is N, N is a positive integer, and M is less than N;
divide the first bit sequence into Y sub-blocks, wherein each of the Y sub-blocks comprises X bits, and X and Y are integers greater than 1;
determine Ai bits of an i^{th} sub-block as to-be-discarded bits, to obtain a second bit sequence, wherein i traverses 1 to Y, Ai is greater than or equal to 1, and there are N−M to-be-discarded bits in the Y sub-blocks; and
map the to-be-sent bit sequence to the second bit sequence.

20. A communication apparatus, comprising a processor, the processor is configured to, when executing the programming instructions, enable the communication apparatus to:
obtain to-be-decoded information;
obtain a first bit sequence, wherein a length of the first bit sequence is N, and N is a positive integer;
divide the first bit sequence into Y sub-blocks, wherein each of the Y sub-blocks comprises X bits, and X and Y are integers greater than 1;
determine Ai bits of an i^{th} sub-block as to-be-discarded bits, to obtain a second bit sequence, wherein i traverses 1 to Y, Ai is greater than or equal to 1, and there are N−M to-be-discarded bits in the Y sub-blocks; and
decode, based on the second bit sequence, the to-be-decoded information, to obtain M information bits, wherein M is a positive integer less than N.
